(19) United States
(12) Patent Application Publication
(10) Pub. No.: US 2005/0254576 A1
(43) Pub. Date: Nov. 17, 2005

(54) METHOD AND APPARATUS FOR COMPRESSING VIDEO DATA

(76) Inventor: Chao-Chih Huang, Tai-Chung Hsien (TW)

Correspondence Address: NORTH AMERICA INTELLECTUAL PROPERTY CORPORATION, P.O. BOX 506, MERRIFIELD, VA, 22116, US

(21) Appl. No.: 10/908,409

(22) Filed: May 11, 2005

(30) Foreign Application Priority Data
May 12, 2004 (TW) 093113314

(51) Int. Cl. H04N 7/12

(52) U.S. Cl. 375/240.03; 375/240.24; 375/240.12

(57) ABSTRACT

A method for compressing a video data having a plurality of frames, each frame having a plurality of macroblocks, includes calculating the complexity of a target macroblock in a target frame; calculating a bit budget for the target macroblock according to the complexity of the target macroblock and the complexity of at least one macroblock in a preceding frame; calculating a quantization parameter for the target macroblock based on its bit budget; and compressing the target macroblock according to the quantization parameter.

### BACKGROUND OF INVENTION

1. Field of the Invention

The present invention relates to digital video compression, and more particularly, to video compressing method and apparatus in a video encoding system.

2. Description of the Prior Art

Rate control is an important issue in video encoding systems, especially when the video encoding systems are applied in an environment in which the bandwidth is limited such as in the plain old telephone service (POTS), or wireless communication or other communication media.

In general, rate control techniques are used for controlling the coefficients of a quantizer of the video encoding system so as to control the output bit rate of the video encoding system to meet the bandwidth limitation of the communication medium. The conventional rate control technique can be divided into two levels: frame level and macroblock level. In the frame level rate control, the bit budget for a target frame to be encoded/compressed is decided according to the type of the target frame (e.g., intra-coded, inter-coded or bidirectional coded) and the buffer situation at that time. In the macroblock level rate control, the coefficient of the quantizer of each macroblock in the target frame is adjusted so as to assure that the encoded target frame meets expected bit numbers.

In order to improve the accuracy for the macroblock level rate control, Ribas-Corbera et al. discloses a rate control technique based on the Lagrange Multiplier in “Rate Control in DCT Video Coding for Low-Delay Communication,” IEEE Transaction on Circuits and Systems for Video Technology, Vol. 9, No. 1, February 1999, the contents of which are incorporated herein by reference in its entirety. The disclosed rate control technique first performs motion estimation for each macroblock in a frame before encoding the frame, and then predicts the sum-up error of all the macroblocks in the frame after each of the macroblocks is motion-compensated. The predicted error is employed as being representative of the complexity of the frame. Next, the coefficient of quantizer of each macroblock in the frame is computed using Lagrange optimization.

However, the rate control method disclosed by Ribas-Corbera et al. performs motion estimation for each of the macroblocks in the frame before encoding the frame. Therefore, the computational requirement is considerable. In addition, significant memory space is also required in the video encoding system for temporary storing the motion vectors corresponding to the macroblocks of the frame.

### SUMMARY OF INVENTION

It is therefore an objective of the claimed invention to provide a method of video data compression being capable of reducing the complexity of computation and the memory requirement.

According to embodiments of the present invention, a method is disclosed for compressing a video data having a plurality of frames, wherein each frame has a plurality of macroblocks. The method comprises calculating the complexity of a target macroblock in a target frame; calculating a bit budget for the target macroblock according to the complexity of the target macroblock and the complexity of at least one macroblock in a preceding frame; calculating a quantization parameter for the target macroblock based on its bit budget; and compressing the target macroblock according to the quantization parameter.

According to embodiments of the present invention, a video compressing device is disclosed comprising a complexity calculator for calculating the complexity of a target macroblock in a target frame; a storage medium coupled to the complexity calculator for storing the complexity of a plurality of macroblocks in a preceding frame; a bit rate controller coupled to the complexity calculator and the storage medium, the bit rate controller for calculating a bit budget for the target macroblock according to the complexity of the target macroblock and the complexity of at least one macroblock in a preceding frame, and for generating a quantization parameter; and a video compressing module coupled to the bit rate controller for compressing the target macroblock according to the quantization parameter.

According to embodiments of the present invention, a method for compressing video data having a plurality of frames is also disclosed, wherein each frame has a plurality of macroblocks. The method comprises the following steps: calculating a characteristic value of a target macroblock in a target frame according to pixel values in the target macroblock; determining a bit budget for the target macroblock according to the characteristic value of the target macroblock and a characteristic value of at least one macroblock in a preceding frame; determining a quantization parameter for the target macroblock based on the bit budget of the target macroblock; and compressing the target macroblock according to the quantization parameter.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a simplified schematic diagram of video data in accordance with an exemplary embodiment of the present invention.

FIG. 2 shows a video compressing device according to an exemplary embodiment of the present invention.

FIG. 3 is a flowchart describing the operations of the video compressing device of FIG. 2 based on a first rate control model of the present invention.

FIG. 4 is a flowchart describing the operations of the video compressing device of FIG. 2 based on a second rate control model of the present invention.

FIG. 5 shows a flowchart illustrating the operations of the video compressing device of FIG. 2 being switched between two rate control models.

### DETAILED DESCRIPTION

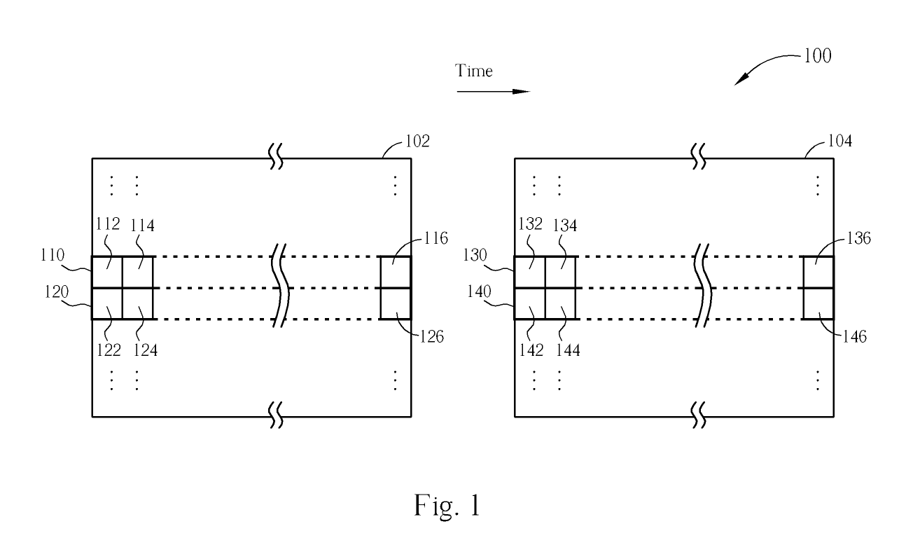

FIG. 1 shows a simplified schematic diagram of a video data 100 in accordance with an exemplary embodiment of the present invention. The video data 100 comprises a frame 102 and a frame 104, in timely order. Each of the frames 102 and 104 has N macroblocks, such as the shown macroblocks 112, 114, 116, 122, 124, 126, 132, 134, 136, 142, 144 and 146. The N macroblocks of each frame can be evenly grouped into M slices, such as the shown slices 110, 120, 130 and 140. Accordingly, the number of macroblock in each slice is W=N/M.

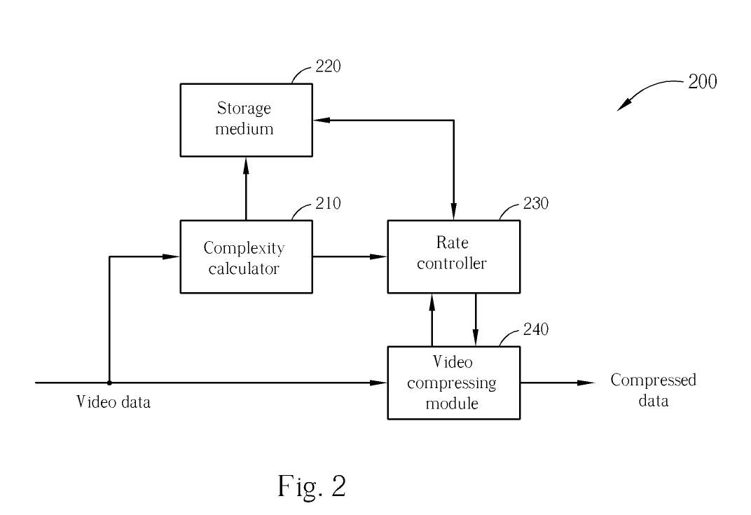

Please refer to FIG. 2, which depicts a video compressing device 200 according to an exemplary embodiment of the present invention. The video compressing device 200 comprises a complexity calculator 210, a storage medium 220, a bit rate controller 230 and a video compressing module 240. In practical implementations, the storage medium 220 can be a buffer or a non-volatile memory. When compressing a frame, the video compressing device 200 only calculates the complexity for a macroblock to be encoded/compressed instead of calculating the complexity for all the macroblocks in the frame in order to reduce the computational requirement. The operation of the video compressing device 200 to encode/compress a target macroblock 142 in the frame 104 is described in the following to illustrate the video compressing method of the present invention. For convenience of description, the target macroblock 142 is hereinafter denoted as the i^{th} macroblock in the frame 104.

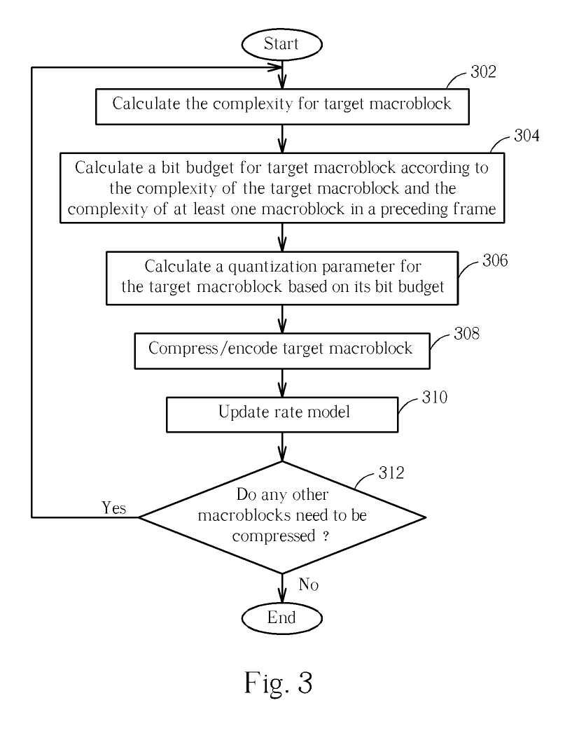

FIG. 3 shows a flowchart describing the operations of the video compressing device 200 based on a first rate control model of the present invention. The steps of the flowchart shown in FIG. 3 are described as follows:

In step 302, the complexity calculator 210 of the video compressing device 200 calculates the complexity of the target macroblock 142. As mentioned above, the complexity calculator 210 performs motion estimation and motion compensation for the target macroblock 142 and then uses a predicted motion-compensated error of the target macroblock 142 as the complexity S(i) corresponding to the target macroblock 142. In practical implementations, the complexity calculator 210 can be a motion estimation and compensation circuit. In this embodiment, the complexity S(i) is the sum of absolute differences (SAD) of the target macroblock 142, but not limited thereto.

In step 304, the bit rate controller 230 then calculates a bit budget R(i) for encoding/compressing the target macroblock 142 according to the complexity S(i) of the target macroblock 142. In general, the frame 104 and the preceding frame 102 may have some similar characteristics, including the distribution of the complexity of macroblocks within the frame. Accordingly, the bit rate controller 230 calculates the bit budget R(i) of the target macroblock 142 based on the complexity of corresponding macroblock(s) in the frame 102 in step 304. For example, the complexity Sp(i+1) of the macroblock 124 in the frame 102 can be employed in the substitution for the unknown complexity S(i+1) of the macroblock 144 in the frame 104. The complexity of the macroblock 126 in the frame 102 can be employed in the substitution for the unknown complexity of the macroblock 146 in the frame 104. In this way, the bit budget R(i) for encoding/compressing the target macroblock 142 can be represented as:

$$R ( i ) = \frac{S ( i )}{{\sum }_{k = i}^{N} {S}_{P} ( k )} \times Rr \qquad ( 1 )$$

wherein Rr is the total number of bits remained available for the frame 104, that can be used to perform texture encoding for the frame 104 before encoding the target macroblock 142; and Sp(k) is the complexity of the k^{th} macroblock of the frame 102.

In practice, the video compressing device 200 can temporarily store the complexity of every macroblock in the frame 102 in the storage medium 220 while compressing the frame 102 in order to support the bit rate controller 230 to perform step 304. As a result, the bit budget R(i) of the target macroblock 142 can be obtained by calculating formula (1) without calculating the complexity of successive macroblocks of the target macroblock 142, e.g. the macroblocks 144, 146 etc., so that the computational requirement is thereby significantly reduced in accordance with the present invention.

In addition, formula (1) merely serves as one embodiment of the bit rate controller 230 to calculate the bit budget R(i) of the target macroblock 142. In fact, in accordance with the same concept of the present invention, the bit rate controller 230 can calculate R(i) based on formula (2):

$$R ( i ) = \frac{S ( i )}{S ( i ) + {\sum }_{k = i + 1}^{N} {S}_{P} ( k )} \times Rr \qquad ( 2 )$$

Next, in step 306, the bit rate controller 230 calculates a quantization parameter Q(i) for the target macroblock 142 according to the bit budget R(i) obtained in step 304. In this embodiment, the bit rate controller 230 calculates the quantization parameter Q(i) of the target macroblock 142 based on following formula:

$$Q ( i ) = \sqrt{K \frac{S ( i )}{R ( i )}} \qquad ( 3 )$$

wherein the setting and adjusting of K is well known in the art and details are therefore omitted herein.

Additionally, the variation in the quantization parameter between two successive macroblocks is usually limited to certain degree. Accordingly, the Q(i) obtained in formula (3) needs to be adjusted. In MPEG-2 standard, for example, the variation in quantization parameter between two successive macroblocks is limited within [−2,2]. Therefore, in step 306, the bit rate controller 230 further adjusts the quantization parameter of the target macroblock 142 based on the following formula:
Q′(i)=saturate(Q(i−1)+saturate(Q(i)−Q(i−1),−2,2),1,31) (4)
wherein Q(i−1) is the quantization parameter of the macroblock 136 prior to the target macroblock 142, Q′(i) is the adjusted quantization parameter of the target macroblock 142, and the function y=saturate(x, a, b) represents that y=a if x<a; y=b if x>b; otherwise y=x.

Afterwards, the video compressing module 240 performs step 308 to encode/compress the target macroblock 142 according to the quantization parameter Q′(i) of the target macroblock 142 transmitted from the bit rate controller 230. When the target macroblock 142 is completely encoded/compressed, the actual number of bits R′(i) that are used for encoding/compressing the target macroblock 142 is obtained.

In order to maintain the accuracy of the first rate control model mentioned above, in step 310, the video compressing device 200 updates the parameters of the first rate control model, such as the value of Rr, K etc., based on the allocated bit number R′(i), the quantization parameter Q′(i) and the complexity S(i) of the target macroblock 142. The step of rate control model update is well known in the art, so that the detailed description is omitted herein for brevity.

Finally, step 31 2 is performed to determine if any other macroblocks need to be compressed after the target macroblock 142 is compressed. If no more macroblocks need to be compressed, the video compressing operation is finished. In the shown embodiment, the video compressing device 200 will repeat steps 302 through 310 to compress the next macroblock 144.

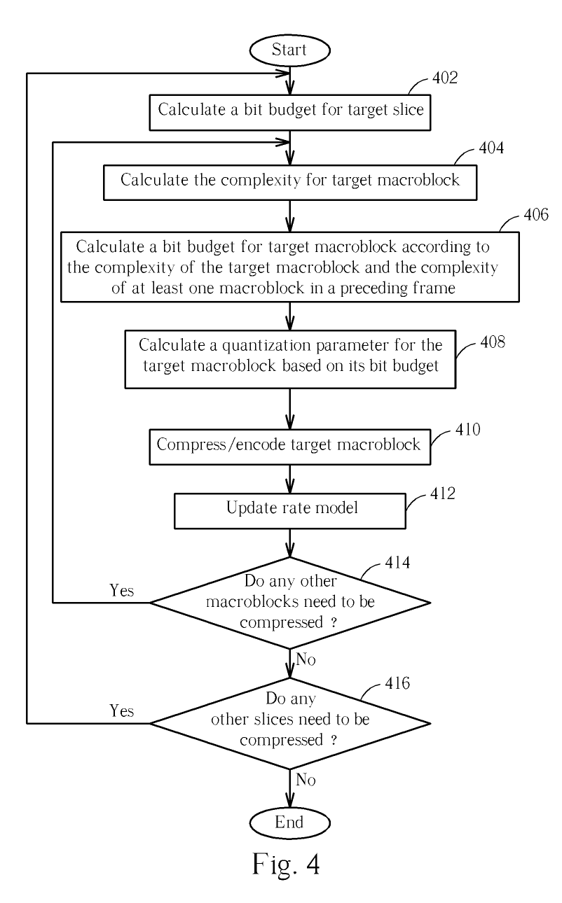

Please refer to FIG. 4, as well as FIG. 1. FIG. 4 shows a flowchart describing the operations of the video compressing device 200 based on a second rate control model of the present invention. For convenience of illustration, the operation of the video compressing device 200 to encode/compress the target macroblock 142 is again employed as an example. Similarly, the target macroblock 142 is denoted as the i^{th} macroblock in the frame 104, and a target slice 140 to which the target macroblock 142 belongs is denoted as the j^{th} slice in the frame 104. The steps of FIG. 4 are described as follows:

Before encoding the target slice 140, the bit rate controller 230 performs step 402 to calculate a bit budget Rs(j) for the target slice 140. Generally, two neighboring slices of a frame have similar distribution of complexity of macroblocks. Accordingly, in this embodiment, the bit rate controller 230 uses the complexity Ss(j−1) of the next slice 130, which is the sum of complexity of every macroblock within the slice 130, to substitute for the unknown complexity Ss(j) of the target slice 140, which is the sum of the unknown complexities of every macroblock within the target slice 140. Additionally, the bit rate controller 230 further uses the complexity Ssp of slices in the frame 102 to substitute for the complexity of a corresponding slice following after the target slice 140. In this embodiment, the bit rate controller 230 calculates the bit budget Rs(j) based on following formula:

$${R}_{S} ( j ) = \frac{{S}_{S} ( j - 1 )}{{\sum }_{h = j}^{M} {S}_{SP} ( h )} Rr \qquad ( 5 )$$

wherein Rr is the total number of bits remained available for the frame 104, that can be used to perform texture encoding for the frame 104 before encoding the target slice 140; and Ssp(h) is the sum of the complexities of every macroblock within the h^{th} slice of the frame 102.

In step 404, the complexity calculator 210 then calculates the complexity S(i) of the target macroblock 142. This step is similar to those described in the above step 302, and the details are therefore omitted herein.

In step 406, the bit rate controller 230 also calculates the bit budget R(i) of the target macroblock 142 based on the complexity S(i). The calculation can be represented as:

$$R ( i ) = \frac{S ( i )}{{\sum }_{k = i}^{W \times j} {S}_{P} ( k )} \times Rsr ( j ) \qquad ( 6 )$$

wherein Rsr(j) is the bit budget remained available for the target slice 140 before encoding the target macroblock 142; and Sp(k) is the complexity of the k^{th} macroblocks in the frame 102. In this embodiment, the target macroblock 142 is the first macroblock of the target slice 140, so that Rsr(j) is equal to Rs(j). Similarly, in another embodiment, formula (6) can be amended as:

$$R ( i ) = \frac{S ( i )}{S ( i ) + {\sum }_{k = i + 1}^{W \times j} {S}_{P} ( k )} \times Rsr ( j ) \qquad ( 7 )$$

The difference between step 406 and step 304 is that the bit budget R(i) of the target macroblock 142 is the available bit budget Rsr(j) of the target slice 140 multiplied by the ratio of the complexity S(i) of the target macroblock 142 to the sum of complexity of the rest of the macroblocks in the target slice 140. The above calculation formula is capable of reducing the variation of the output bit rate of the video compressing device 200.

Steps 408 and 410 are similar to those described in the above steps 306 and 308, and further details are omitted for brevity. In addition, step 412 is similar to the above step 310. The difference between step 412 and 310 is that one more parameter Rsr(j), i.e. the available bit budget of the target slice, needs to be updated in step 412.

Next, step 414 is performed. If all macroblocks of the target slice 140 are completely compressed, the flow proceeds to step 416. If any other macroblock of the target slice 140 needs to be compressed, the video compressing device 200 repeats above steps 404 through 412 for the next macroblock, such as the macroblock 144 in this embodiment.

Finally, the video compressing device 200 performs step 416 to determine if any other slice of the frame 104 needs to be compressed. If no more slices need to be compressed, the video compressing operation is finished; otherwise, the video compressing device 200 repeats above steps 402 through 414 for the next slice.

Each of the above two rate control models has its merits. For example, when the video compressing device 200 uses the first rate control model, the quality of compressed video image is usually better than when using the second rate control model. On the other hand, when the video compressing device 200 uses the second rate control model, the variation of output bit rate is smaller than when using the first rate control model. Therefore, the operation of the video compressing device 200 of the present invention can be alternatively switched between the two rate control models to balance the quality of compressed video image and the variation of output bit rate.

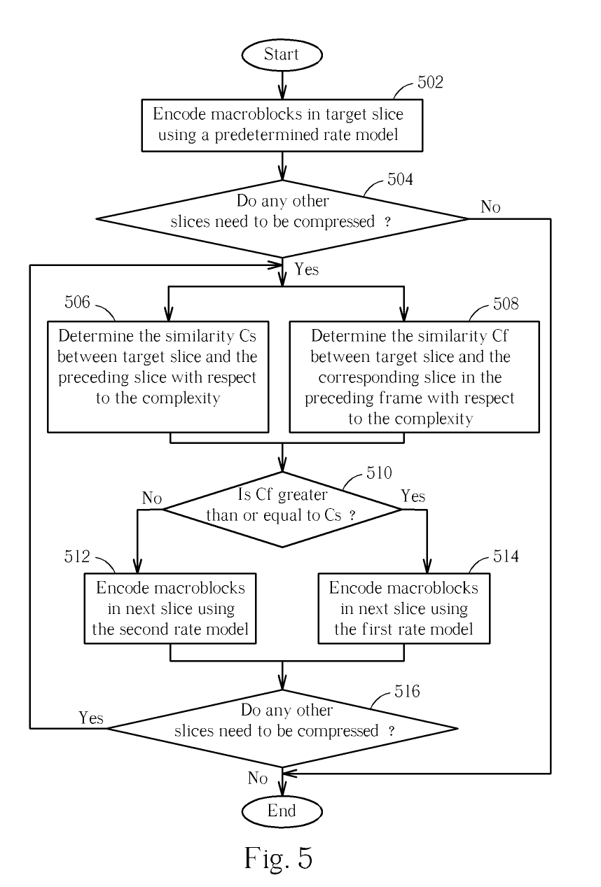

FIG. 5 shows a flowchart illustrating the operations of the video compressing device 200 being switched between two rate control models according to one embodiment of the present invention.

In step 502, the video compressing device 200 encodes every macroblock of the target slice 140 based on a predetermined rate control model, such as one of the first and the second rate control models or the other.

When all the macroblocks of the target slice 140 are completely encoded/compressed, step 504 is performed to determine if any other slices need to be compressed. If no more slices need to be compressed, the video compressing operation is finished; otherwise, the flow proceeds to steps 506 and 508.

In step 506, the bit rate controller 230 determines the similarity Cs between the target slice 140 and the preceding slice 130 with respect to the complexity. In this embodiment, for example, the bit rate controller 230 calculates the similarity Cs between the target slice 140 and the preceding slice 130 by computing the sum of absolute difference (SAD) between corresponding macroblocks of the two slices. The operation can be represented as:

$$Cs = - {\sum }_{k = ( W - 1 ) \times j + 1}^{W \times j} \vert S ( k ) - S ( k - W ) \vert \qquad ( 8 )$$

On the other hand, in step 508, the bit rate controller 230 determines the similarity Cf between the target slice 140 and the corresponding slice 120 in the preceding frame 102 with respect to the complexity. In this embodiment, for example, the bit rate controller 230 calculates the similarity Cf between the target slice 140 and the corresponding slice 120 by computing the sum of absolute difference (SAD) between corresponding macroblocks of the two slices. The operation can be represented as:

$$Cf = - {\sum }_{k = ( W - 1 ) \times j + 1}^{W \times j} \vert S ( k ) - {S}_{p} ( k ) \vert \qquad ( 9 )$$

In step 510, the bit rate controller 230 compares Cs and Cf to determine whether the complexity of the target slice 140 is closer to that of the preceding slice 130 within the same frame 104 or that of the corresponding slice 120 within the preceding frame 102.

In this embodiment, if Cf is greater than (or equal to) Cs, it means that the distribution of complexity of the target slice 140 is closer to that of the slice 120 in the frame 102. Accordingly, the video compressing device 200 then performs step 514 to encode/compress every macroblock in the next slice (not shown) following after the target slice 140 based on the first rate control model mentioned above. Alternatively, if Cf is less than Cs, it means that the distribution of complexity of the target slice 140 is closer to that of the preceding lice 130. The video compressing device 200 then performs step 512 to encode/compress every macroblock in the next slice following after the target slice 140 based on the second rate control model.

As mentioned above, by switching between the two disclosed rate control models, the video compressing device 200 is capable of significantly reducing computational requirement and accurately balancing the compressed video quality and output bit rate. Also note that the foregoing calculation of Cs and Cf merely serves as one embodiment of similarity calculation. A person skilled in the art can adopt other calculation to measure the similarity between two slices.

Those skilled in the art will readily observe that numerous modifications and alterations of the device and method may be made while retaining the teachings of the invention. Accordingly, the above disclosure should be construed as limited only by the metes and bounds of the appended claims.

1. A method for compressing video data having a plurality of frames, each frame having a plurality of macroblocks, the method comprising the following steps:
calculating the complexity of a target macroblock in a target frame;
calculating a bit budget for the target macroblock according to the complexity of the target macroblock and the complexity of at least one macroblock in a preceding frame;
calculating a quantization parameter for the target macroblock based on its bit budget; and
compressing the target macroblock according to the quantization parameter.

2. The method of claim 1, wherein the step of calculating the bit budget for the target macroblock is performed in accordance with an available bit budget of the target frame before compressing the target macroblock and the ratio of the complexity of the target macroblock to the complexity of at least one macroblock in the preceding frame.

3. The method of claim 1, wherein the step of calculating the quantization parameter for the target macroblock is performed based on the bit budget of the target macroblock and a quantization parameter of a preceding macroblock.

4. The method of claim 1, wherein the step of calculating the bit budget for the target macroblock further comprises:
calculating a bit budget for a target slice to which the target macroblock belongs.

5. The method of claim 4, wherein the step of calculating the bit budget for the target macroblock is performed in accordance with the complexity of the target macroblock, the complexity of at least one macroblock in the preceding frame, and the bit budget of the target slice.

6. The method of claim 4, wherein the step of calculating the bit budget for the target macroblock further comprises:
calculating the bit budget for the target slice according to the complexity of a preceding slice within the target frame and the complexity of at least one macroblock in the preceding frame;
wherein the complexity of each slice corresponds to the sum of complexity of a plurality of macroblocks in the slice.

7. The method of claim 1, wherein if the target macroblock is the first macroblock of a target slice to which the target macroblock belongs, the method further comprises:
respectively determining the similarity between a first slice and a second slice with respect to the complexity and the similarity between the first slice and a third slice with respect to the complexity; and
determining whether or not to calculate the bit budget for the target slice according to the determined similarities;
wherein the first slice is the preceding slice of the target slice within the target frame, the second slice is the preceding slice of the first slice within the target frame, and the third slice is a slice corresponding to the first slice within a preceding frame.

8. The method of claim 7, further comprising:
if the similarity between the first slice and the second slice is greater than the similarity between the first slice and the third slice, calculating the bit budget for the target slice.

9. The method of claim 8, further comprising:
calculating the bit budget for the target slice according to the complexity of the first slice and the complexity of at least one slice in the preceding frame;
wherein the complexity of each slice corresponds to the sum of complexities of a plurality of macroblocks in the slice.

10. The method of claim 7, further comprising:
if the similarity between the first slice and the second slice is less than the similarity between the first slice and the third slice, calculating the bit budget for the target macroblock in accordance with an available bit budget of the target frame before compressing the target macroblock and the ratio of the complexity of the target macroblock to the complexity of at least one macroblock in the preceding frame.

11. The method of claim 1, wherein the step of calculating the complexity of the target macroblock is performed according to an error value after the target macroblock is motion estimated and compensated.

12. A video compressing device for compressing video data having a plurality of frames, each frame having a plurality of macroblocks, the video compressing device comprising:
a complexity calculator for calculating the complexity of a target macroblock in a target frame;
a storage medium coupled to the complexity calculator for storing the complexity of a plurality of macroblocks in a preceding frame;
a bit rate controller coupled to the complexity calculator and the storage medium, the bit rate controller for calculating a bit budget for the target macroblock according to the complexity of the target macroblock and the complexity of at least one macroblock in a preceding frame, and for generating a quantization parameter; and
a video compressing module coupled to the bit rate controller for compressing the target macroblock according to the quantization parameter.

13. The video compressing device of claim 12, wherein the complexity calculator is a motion estimation and compensation device.

14. The video compressing device of claim 12, wherein the bit rate controller calculates the bit budget for the target macroblock in accordance with an available bit budget of the target frame before compressing the target macroblock, and the ratio of the complexity of the target macroblock to the complexity of at least one macroblock in the preceding frame.

15. The video compressing device of claim 12, wherein if the target macroblock is the first macroblock of a target slice to which the target macroblock belongs, the bit rate controller further determines the similarity between a first slice and a second slice with respect to the complexity, and the similarity between the first slice and a third slice with respect to the complexity, and determines whether or not to calculate the bit budget for the target slice according to the determined similarities;
wherein the first slice is the slice preceding the target slice within the target frame, the second slice is the slice preceding the first slice within the target frame, and the third slice is a slice corresponding to the first slice within a preceding frame.

16. The video compressing device of claim 15, wherein if the similarity between the first slice and the second slice is greater than the similarity between the first slice and the third slice, the bit rate controller calculates the bit budget for the target slice in accordance with the complexity of the target macroblock, the complexity of at least one macroblock in the preceding frame, and the bit budget of the target slice.

17. The video compressing device of claim 12, wherein the bit rate controller adjusts the parameters of the bit rate controller according to the result after the target macroblock is compressed by the video compressing module.

18. A method for compressing video data having a plurality of frames, each frame having a plurality of macroblocks, the method comprising the following steps:
calculating a characteristic value of a target macroblock in a target frame according to pixel values in the target macroblock;
determining a bit budget for the target macroblock according to the characteristic value of the target macroblock and a characteristic value of at least one macroblock in a preceding frame;
determining a quantization parameter for the target macroblock based on the bit budget of the target macroblock; and
compressing the target macroblock according to the quantization parameter.
